(19) United States
(12) Patent Application Publication
(10) Pub. No.: US 2015/0348654 A1
(43) Pub. Date: Dec. 3, 2015

(54) Organically Cooled Nuclear Reactor for Enhanced Economics and Safety

(71) Applicants: Koroush Shirvan, Boston, MA (US); Eric Christopher Forrest, Saugus, MA (US)

(72) Inventors: Koroush Shirvan, Boston, MA (US); Eric Christopher Forrest, Saugus, MA (US)

(73) Assignee: MASSACHUSETTS INSTITUTE OF TECHNOLOGY, Cambridge, MA (US)

(21) Appl. No.: 14/615,396

(22) Filed: Feb. 5, 2015

Related U.S. Application Data
(60) Provisional application No. 62/003,414, filed on May 27, 2014.

(51) Int. Cl. G21C 15/06; G21C 3/328; G21C 7/08; G21C 3/28; G21C 3/07

(52) U.S. Cl. CPC G21C 15/06; G21C 3/28; G21C 3/07; G21C 7/08; G21C 3/328; G21C 2003/048

(57) ABSTRACT

An organically cooled nuclear reactor comprises fissionable fuel pellets and a neutron-moderator matrix in which the fissionable fuel pellets are distributed. The neutron-moderator matrix also defines coolant channels for flow of an organic coolant.

### RELATED APPLICATION

This application claims the benefit of U.S. Provisional Application No. 62/003,414, filed 27 May 2014, the entire content of which is incorporated herein by reference.

### BACKGROUND

Nuclear power produces about 20% of the electricity generated in the United States and over 11% of the electricity generated worldwide. The “organic” nuclear concept was originally implemented in Idaho as a test reactor in 1957 [see Parkins, W. E, et al., “Organic-Moderated Reactors for Central Station Power,” AIEE (1959)]. An organic nuclear reactor was subsequently built in Piqua, Ohio rated at 45 MWe. The organic program in the US, however, only lasted for a few years as the irradiation damage to organic coolant caused unpredictable operational issues.

The U.S. Atomic Energy Commission (AEC) partnered with Canada to design and build a 60 MWe heavy water moderated, organically cooled reactor concept to reduce radiation damage to the coolant [see Adamas, R. E. et al., “An Evaluation of Heavy-Water-Moderated Organic-Cooled Reactors,” ORNL-3921, UC-80-Reactor Technology, (1967)]. This power reactor ran from 1965 until 1985, at which time the U.S. Department of Energy terminated funding support. The programs in Italy and Russia also lost their support due to the greater focus on light water reactor (LWR) technology.

The Canadian design operated with a high capacity factor, similar to light water reactors. However, the organic system in that design used heavy water as the moderator, resulting in low power density. Up until the early 1990's, fears of limited uranium reserves led to a focus on fast-reactor concepts, which could breed fissile material, such as in sodium-, lead-, and gas-cooled designs. The organic reactor concept operates with a thermal-neutron spectrum similar to that of light water reactors with the same operating capacity factor; consequently, there was little interest in continuing research on the organic concept.

Since then, new light-water-reactor designs have incorporated more-advanced safety systems as a result of perceived shortfalls in older light-water reactors, dramatically increasing costs. Additionally, many of the key nuclear reactor components are not manufactured domestically. Consequently, the cost of light-water-reactor plant operation has only increased; and no new nuclear plants have been added to the grid due to the drop in natural gas prices and the consequent shift toward natural gas as an energy source. The expansion of highly subsidized renewables has also hurt further nuclear power expansion, despite nuclear power being the only significant zero-emission option for expanding base load electricity production.

Since the 1970's, only light water reactors (LWR's) have successfully penetrated the commercial nuclear market. Nuclear startups have failed due to the excessive cost of research and development (R&D) and licensing for non-LWR concepts. Such reactor concepts have overly concentrated on higher operating temperatures and reduced fuel consumption for improved economics, which invariably requires multi-billion dollar investment in R&D. These other concepts include molten salt, fluoride salt cooled high-temperature (FHR), lead/bismuth cooled, sodium cooled and high-temperature gas cooled or gas fast reactors. Most of these advanced reactor designs require 15-20% enriched fuel, which requires a multibillion-dollar investment in the nuclear fuel infrastructure (in the United States).

The current nuclear startup landscape is populated by small reactor concepts that focus on inherent safety and require lower up-front capital cost but are still plagued by large R&D costs for commercialization. In addition, such reactor concepts would produce lower revenue compared to existing large-scale plants, greatly increasing the overall levelized cost of electricity. The complete recipe for successful market penetration, therefore, is low R&D cost, lower capital cost per MWe, and inherently safe operation in comparison to existing light-water-reactor designs.

### SUMMARY

An organically cooled nuclear reactor and a method for generating power there from are described herein, where various embodiments of the reactor and method may include some or all of the elements, features and steps described below.

A simple, cost-effective, and inherently safe nuclear core design cooled by an organic coolant is presented that utilizes existing nuclear fuel infrastructure and materials. The novel design disclosed herein can meet the ultimate desire in reducing construction and operating costs when compared to a commercial light water reactor plant. This core design is an attractive option that is cost competitive with other power technologies, especially in developing countries. Considering that the licensing process for new nuclear technology may take over a decade, the introduction of a unique and economically superior reactor technology comes at an opportune time.

An organically cooled nuclear reactor, comprises fissionable fuel pellets; a neutron-moderator matrix in which the fissionable fuel pellets are distributed, wherein the neutron-moderator matrix also defines coolant channels for coolant flow; and an organic coolant in the coolant channels.

The fissionable fuel pellets can comprise (e.g., consist essentially of) a uranium composition. In particular embodiments, the uranium composition can be selected from at least one of the following: uranium oxide, uranium carbide, uranium nitride, and a uranium metal or alloy. The fissionable fuel pellets can have cruciform-shaped cross-sections. The cruciform-shaped cross-section of each fissionable fuel pellet can have an area in a range of about 0.5 cm² to about 1 cm².

The coolant channels can each have a diameter in a range of about 0.5 cm² to about 1.5 cm².

The organically cooled nuclear reactor can further include a zirconium composition positioned about the fissionable fuel pellets and the neutron-moderator matrix.

Cladding comprising at least one of zirconium alloy, silicon carbide or iron can line the neutron-moderator matrix and separate the neutron-moderator matrix from the fissionable fuel pellets.

The coolant can be substantially free of water. In particular embodiments, the organic coolant can comprise at least one of a terphenyl composition and a dimethyl polysiloxane.

The neutron-moderator matrix can be in a solid form and can comprise at least one of graphite and zirconium hydride.

Also described is a method for generating power via nuclear fission in a nuclear reactor that includes fissionable fuel pellets and a neutron-moderator matrix in which the fissionable fuel pellets are distributed, wherein the neutron-moderator matrix also defines coolant channels. The method comprises generating a controlled fission reaction in the fuel pellets, resulting in a release of neutrons and heat generation; moderating the released neutrons with the neutron-moderator matrix; and flowing organic coolant through the coolant channels to extract the generated heat. The nuclear reactor can operate with a power density in a range from 40-60 KW/L. The nuclear reactor can be operated at a temperature in a range of about 250° C. to about 400° C. and at a pressure in a range of about 50 to about 1 MPa.

The method can further comprise shutting down the reactor and cooling the reactor after shutdown mostly or entirely by air cooling.

In additional embodiments, the method can further comprise operating a camera in the nuclear reactor to monitor inventory of the fissionable fuel pellets in the nuclear reactor.

In additional embodiments, the method can further comprise forming the fuel pellets from plutonium in weapons or from a used nuclear fuel stockpile.

### BRIEF DESCRIPTION OF THE DRAWINGS

FIG. 1 is a sectional illustration of an embodiment of the organically cooled nuclear reactor design.

FIG. 2 shows maximum temperatures reached in a quarter symmetric model of the fuel, helium gap, cladding, and graphite combination in a simulation of operation at steady state with organic cooling.

FIG. 3 shows maximum temperatures reached in a quarter symmetric model of the fuel, helium gap, cladding, and graphite combination in a simulation of shutdown with air natural convection cooling.

FIG. 4 is a sectional illustration of another embodiment of the organically cooled nuclear reactor design.

In the accompanying drawings, like reference characters refer to the same or similar parts throughout the different views; and apostrophes are used to differentiate multiple instances of the same or similar items sharing the same reference numeral. The drawings are not necessarily to scale; instead, emphasis is placed upon illustrating particular principles in the exemplifications discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances. Percentages or concentrations expressed herein can represent either by weight or by volume.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

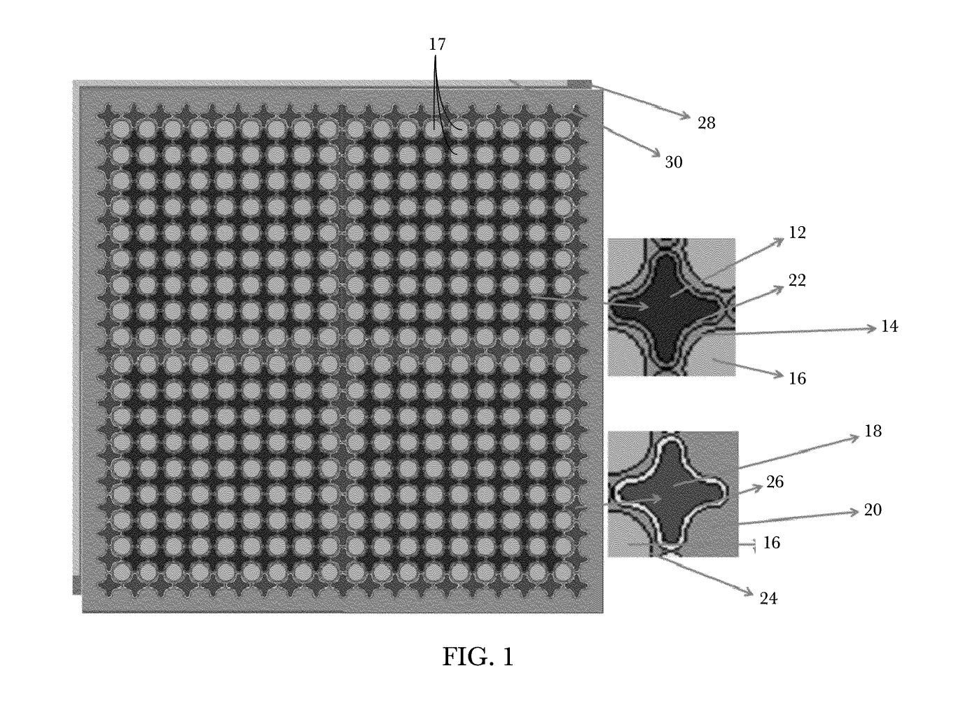

In embodiments of the organic nuclear design presented herein, as shown in FIG. 1, solid fissionable fuel pellets 12 are arranged in an internal graphite matrix 14. The fuel pellets 12 can have a cruciform-shaped cross-section; and holes can be defined in the graphite matrix 14 around the fuel region where the coolant 16 flows. Single or multiple columns of a moderator 18, such as zirconium hydride (ZrHₓ, where x can range from 1.4-1.6), can surround the fuel 12, graphite 14, and coolant channel 17 region, as shown in FIG. 1. The sectional geometry of these components, as shown, can be arranged in a square array. This geometry, however, can alternatively be arranged in hexagonal or circular configurations, provided the fuel 12 and the coolant 16 stay in the central region surrounded by the moderator 18 in an outer graphite matrix 20. Such an arrangement results in reduction of radiation energy deposited in the coolant 16 and yet maintains safe operation (i.e., negative feedback reactivity coefficients). The power density of such a design varies from 40-60 kW/L, depending on the size and type of fuel utilized. This power density is comparable to that of boiling water reactors (BWR's), which comprise about 30% of the nuclear reactors in the United States.

Components in the nuclear reactor design are described in greater detail, below.

Fuel:

In the illustrated embodiment, the fissionable fuel 12 is cruciform in shape to enhance heat transfer as well as to shield the coolant channels 17 from energetic radiation. To further reduce the maximum fuel temperature, an annular hole can be manufactured in the central region of the cruciform fuel 12. In this annular design, the hole can also be plugged by graphite or an inert solid material to alleviate concerns over fuel fragments falling down the hole as the fuel undergoes irradiation. The approximate size of the cruciform fuel pellets 12 are on the same order as fuel pellets in current light water reactors with a top surface area of 0.5-1.0 cm² (e.g., about 0.72 cm²).

The fuel 12 in the base design is made from standard uranium dioxide (UO₂) fuel with less than 5% U²³⁵ enrichment. In previous organic reactors, carbide fuel or metal fuel was used. In order for the design to reach its maximum potential, high conductivity carbide (UC), metal (UZr or UMo), or nitride (UN) fuel can be used [see Petti D., et al., “Fuels for Advanced Nuclear Energy Systems,” MRS Bulletin, Vol 34 (2009) and Snelgrove J. L., et al., “Development of very-high-density low enriched uranium fuels,” Nuclear Engineering and Design (1997)]. Such fuels typically cannot be used for light water reactors due to exothermic chemical reaction with water at high temperatures. However, this reaction can be prevented by the design disclosed herein, where the fuel 12 is surrounded in a graphite composite block 14, and where water is not present in the core (i.e., the reactor core is free of water or contains no more than trace amounts of water). Furthermore, the organic fluids are fully compatible with these three fuel forms in addition to the traditional lower thermal conductivity UO₂.

The cladding 22 of the fuel 12 can be formed of zirconium, as zirconium is a proven cladding material. The cladding 22 can alternatively be replaced by a SiC multilayer composite, as described in J. D. Stempien, et al., “Characteristics of Composite Silicon Carbide Fuel Cladding After Irradiation Under Simulated PWR Conditions,” Nuclear Technology, Vol. 183 (2013). This SiC multilayer composite was proposed as an advanced nuclear fuel cladding in PCT Patent Application No. PCT/US2012/042981 (WO 2012/174548 A1). In other embodiments, iron-based metallic cladding can be used. The cladding 22 has an upper plenum region similar to that of current light water reactors to retain fission product gas release as fuel 12 is irradiated. The lower plenum only extends the metallic cladding 22 to promote mixing and avoid possible plugging of the coolant channels 17.

Coolant:

For a base design, the proven 1,3-di(phenyl)benzene (C18F114) organic fluid (available commercially as SANTOWAX-OM from the Solutia Inc subsidiary of Eastman Chemical Company) can be used as the coolant 16 (see U.S. Pat. No. 3,203,867); and the coolant 16 can be free or substantially free (e.g., no more than trace quantities) of water. The SANTOWAX organic fluid is a terphenyl made out of heavy chains of hydrocarbons. These organic fluids, however, have been considered somewhat harmful to the environment, causing mortality to fish when ingested. In alternative embodiments, a silicone fluid is used as the organic fluid coolant 16. Silicone fluids, such as SYLTHERM 800 stabilized heat transfer fluid (HTF) (available from Dow Corning Corporation), do not exhibit such issues with toxicity and do not adversely affect the environment of aquatic species. The events at Fukushima highlighted the need for low-toxicity coolants; and this is a primary reason to use the silicone fluid. The silicone fluid can comprise a dimethyl polysiloxane molecule, commercially available in many forms, such as SYLTHERM 800 stabilized HTF. Such silicone fluids are thermally stable up to 400° C., which is the peak coolant wall temperature limit in the base design, and are expected to exhibit the desired radiation stability with the base design because the silicone fluids are relatively transparent to neutrons and, therefore, induce low levels of radioactivity.

The coolant 16 flows through channels 17 in the graphite 14, wherein the interior walls of the channels 17 can be coated with a protective oxide film to avoid possible interaction of graphite 14 with free oxygen in case of radiation degradation of the silicone fluid coolant 16. Such silicone fluids exhibit excellent compatibility with common materials, such as carbon steel. Since silicone fluid is liquid at room temperature, it is also very attractive for use in safety system tanks as well as in the spent fuel pool.

The organic coolant 16 has less-desirable heat transfer and hydraulic characteristics than water at nuclear-reactor conditions. Nevertheless, to improve heat transfer in the system, one can apply twisted tapes or extruded fins in the coolant channels 17 to increase the heat transfer by over 20%. Additionally, separate cladding material 24 can be fitted within the coolant channels 17 to reduce dependence on the graphite 14 as the main structural component.

Moderator:

The base design operates in the thermal neutron spectrum, which is advantageous over other advanced concepts, when fuel enrichment and reprocessing constraints in the United States are considered. Use of a moderator 18 slows down the fast neutrons generated from the fission reaction to thermal (lower) energy ranges. While the organic fluid coolant 16 provides large moderating power in slowing down neutrons, in this design, the base graphite matrix 14 and ZrHₓ moderator 18 (in circular or cruciform shape) also provide moderation in order to reduce the radiation energy deposited on the organic coolant 16. In the present design, as shown in FIG. 1, many coolant channels 17 are provided around the ZrHₓ moderator 18 to keep its temperature limited to 500° C. The ZrHₓ moderator 18 also is cladded by cladding material 26 with low permeability to hydrogen release, such as molybdenum or a SiC composite with an inner monolithic layer.

Control:

The cruciform moderator control rods 18 positioned around the assembly, as shown in FIG. 1, can be inserted from the top (primary design) or bottom to effectively start and shutdown the fission reaction in the reactor. Finger-type control rods can also be utilized from the top of the core. Control rod casing 28 (formed, e.g., of carbon steel or stainless steel) and neutron-absorbing material 30 can line the outer graphite casing 20. The neutron absorber material 30 can be identical to that which is used in current light water reactors (e.g., B₄C or AgInCd), although cheaper structural materials may be used in place of stainless steel due to the low corrosivity of the proposed organic fluids.

The newly developed cruciform electromagnetic control drives for the Advanced Boiling Water Reactor, currently operating in Japan, can be used for the base design. In order to lower power peaking in the fuel 12 in the design of FIG. 1, burnable poison material, similar to that which is found in light water reactors, can be used, since the fuel 12 can be identical in composition. These burnable poisons include an integrated fuel burnable absorber (e.g., a boron compound that is sprayed on the individual pellets or gadolinium oxide mixed with the uranium dioxide). The use of a soluble absorber fluid, such as boric acid in water, may be used. Such a modification, however, may jeopardize the low induced radioactivity of this design.

Operation:

The operating pressure and temperature for the primary design can be around atmospheric pressure (˜101 kPa) or higher and 300° C., respectively. Multiple assemblies are placed in a carbon steel vessel that can be made using multiple welds, thus facilitating manufacture and enabling vessel fabrication in any country. The nuclear fuel is expected to have an in-core residence time as long as that of current light water reactors (˜5 years). The excess hydrogen pickup in current light-water-reactor cladding limits the power extracted per mass of uranium. In this design, such hydrogen embrittlement is reduced compared to a light water reactor, leading to 20-25% better fuel utilization (e.g., burnup). The graphite 14 and moderator 18 can be replaced as their properties degrade, though that replacement cycle is expected to be on the order of every 10 years. The moderator 18 arrangement allows the assemblies to operate with greater independence (e.g., decoupled from nuclear feedback), which can enable online refueling, which is not possible in current light water reactors. The low induced radioactivity of the primary system also allows maintenance to be performed at high-power conditions, increasing the concept's capacity factor over a light water reactor.

Power Cycle and Turbomachinery:

The power conversion system can be identical to that of a current light water reactor, which is a steam Rankine cycle. The steam generators can have U-tube designs; and the secondary side pressure is around 7 MPa, resulting in a thermodynamic efficiency of about 32%, which is similar to that of light water reactors. The U-tube steam generators can be placed on top of the reactor in an integral fashion, similar to most of the small modular reactor (SMR) designs, as described in U.S. Pat. No. 8,331,523 B2. For a more compact design, standard once-through steam generators, such as helical or shell-and-tube steam generators, can also be utilized.

Safety by Design:

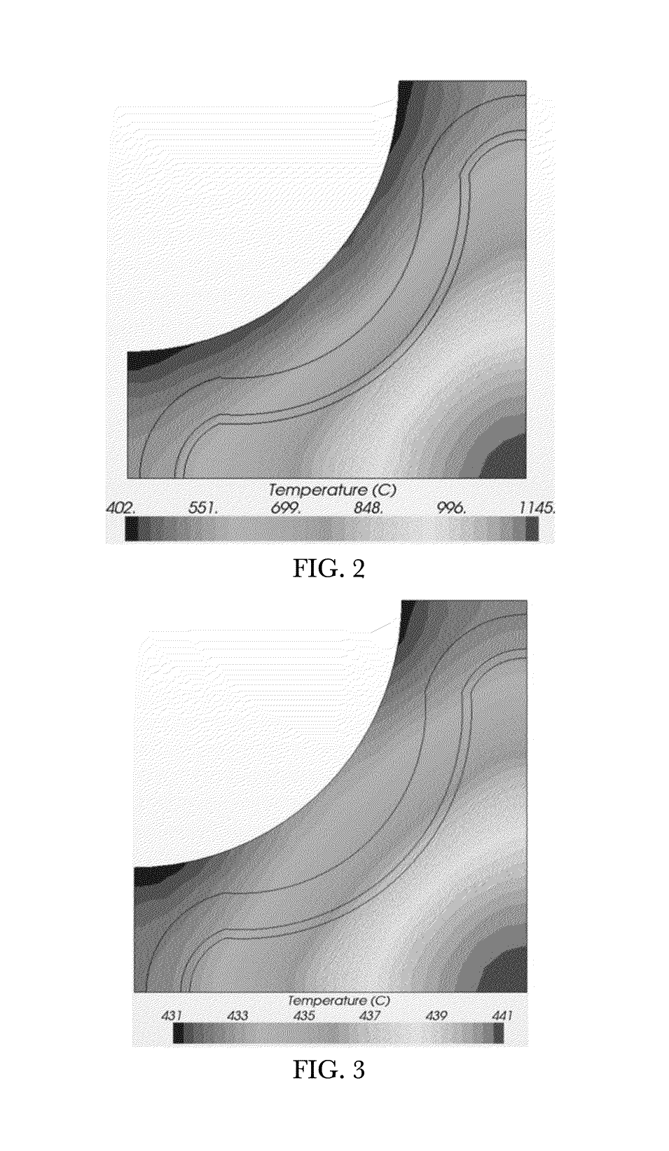

A key safety feature is the ability of the cruciform-shaped fuel 12, combined with graphite 14, to attain very low temperatures throughout operation and following shutdown. If desired, the coolant can be removed from the reactor upon loss of both offsite and onsite power, which happened at Fukushima, in order to eliminate the risk of plugging coolant channels 17 due to thermal degradation of organic coolant 16 at high temperatures. With a power density of 40 kW/L, the design can use air cooling without violating fuel 12 and cladding 22 temperature limits, which are 1800° C. and 2800° C., respectively. FIG. 2 shows that for a quarter symmetric model of the fuel 12, the helium gap, the cladding 22, and the graphite 14 combination cooled with the organic silicone fluid coolant 16, the maximum temperature during steady state is well below the melting point of the UO₂ fuel 12 at twice the rated power of the base design (40 kW/L).

Positioning the coolant channels 17 close to each of the cruciform fuel elbows provides an inherent safety feature in case a single coolant channel 17 plugs under normal conditions, as the other three channels 17 can sufficiently remove heat from the fuel 12 without violating any safety limits. It is also noted that this design includes coolant channels 17 on the order of 1 cm in diameter, which reduces the potential for plugging under normal conditions due to debris or degradation of the organic coolant 16.

FIG. 3 shows a similar simulation with natural convection air cooling after reactor shut down. Though the heat transfer rate is reduced significantly, the design remains below temperatures of concern for oxidation of graphite 14 by air. Using air-cooling following shutdown also reduces concerns over excess hydrogen production from the organic fluid coolant 16 if high temperatures were reached due to abnormal conditions. For hypothetical severe accidents, such as a meteorite strike on the reactor, the hydrogen leakage from the zirconium hydride moderator 18 at very high temperatures results in the natural shutdown of the fission reaction. The graphite matrix 14 will also be able to provide a strong structural support as well as a thermal heat sink, preventing the fuel 12 from melting and being released to the environment.

In the base design, tanks with borated organic fluids (e.g., SILLY PUTTY silicone polymer from Crayola LLC) are situated above the reactor vessel and connected to the coolant channels 17 with closed valves in the rare event of a loss-of-coolant accident, which is very unlikely due to operation near atmospheric pressure. The natural circulation of the organic fluid 16 in the coolant channels 17 is sufficient under loss-of-flow accidents to maintain the integrity of all of the structural components. Due to the absence of exothermic reactions with material in this design, the spent fuel pools are expected to be even safer than those used at current light water reactor sites due to the higher margin to boiling.

Proliferation Resistance:

In the base design, cameras can be used to closely monitor the fuel inventory inside the vessel, as the chosen organic fluid coolant 16 is transparent. The ability to operate a camera in an organic nuclear reactor vessel, which was demonstrated in the early conceptions [see Adamas R. E., et al., “An Evaluation of Heavy-Water-Moderated Organic-Cooled Reactors,” ORNL-3921, UC-80-Reactor Technology, (1967)], allows for online inspection of fuel inventory, which is not feasible with the current light water reactors. Since the utilized fuel 12 can be identical to that of a light water reactor, the additional ability for online monitoring allows this design to have a higher degree of proliferation resistance.

Due to the higher degree of moderating power compared to LWRs, the design will be a more-effective plutonium burner than LWRs. This enables plutonium in weapons and used nuclear fuel stockpiles to be burned in the same manner as in current Canada deuterium uranium (CANDU) reactors [see Boczar M. J., et al., “Advanced Nuclear Systems Consuming Excess Plutonium,” NATO ASI Series, Volume 15, (1997)].

Alternative Embodiment:

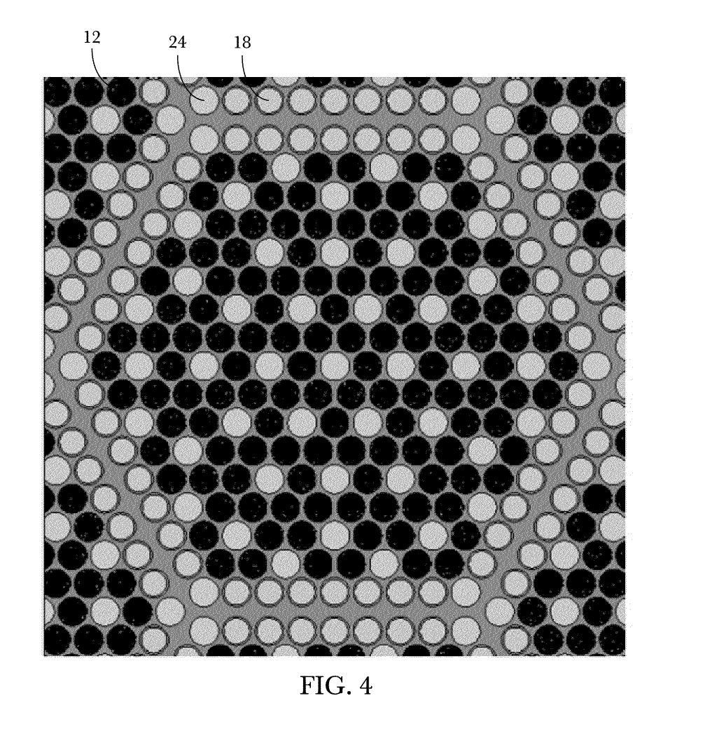

To reduce the role of the moderator 18 on the change in reactivity during a coolant density change, graphite 14 can be used around the fuel 12 to increase the mean free path of the neutrons, while ZrH_{1.6} moderator 18 can be placed in the outer region in order to still absorb the majority of fast fluence. FIG. 4 represents such a system, where a 5% decrease in coolant density results in 165 pcm decrease in reactivity. The assembly hexagonal side is 27 cm, while each circular hole for the coolant 16 or fuel 12 or ZrH_{1.6} moderator 18 is 1 cm in diameter.

In FIG. 4, the ratio of the fuel 12 to coolant 16 seen is for the least-packed fuel form considered, tristructural-isotropic (TRISO) fuel at 10% enrichment. In terms of the structural integrity of graphite 14, the representative assembly shown in FIG. 4 can utilize burnable poisons to uniformly distribute the temperature, which reduces the thermal stresses experienced in the graphite 14.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, 1/5^{th}, 1/3^{rd}, 1/2, 2/3^{rd}, 3/4^{th}, 4/5^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. An organically cooled nuclear reactor, comprising:
fissionable fuel pellets;
a neutron-moderator matrix in which the fissionable fuel pellets are distributed, wherein the neutron-moderator matrix also defines coolant channels for coolant flow; and
an organic coolant in the coolant channels.

2. The organically cooled nuclear reactor of claim 1, wherein the fissionable fuel pellets comprise a uranium composition.

3. The organically cooled nuclear reactor of claim 2, wherein the fissionable fuel pellets consist essentially of a uranium composition.

4. The organically cooled nuclear reactor of claim 2, wherein the uranium composition is selected from at least one of the following: uranium oxide, uranium carbide, uranium nitride, and a uranium metal or alloy.

5. The organically cooled nuclear reactor of claim 1, wherein the fissionable fuel pellets have cruciform-shaped cross-sections.

6. The organically cooled nuclear reactor of claim 5, wherein the cruciform-shaped cross-section of each fissionable fuel pellet has an area in a range of about 0.5 cm² to about 1 cm².

7. The organically cooled nuclear reactor of claim 6, wherein the coolant channels each have a diameter in a range of about 0.5 cm² to about 1.5 cm².

8. The organically cooled nuclear reactor of claim 1, further comprising a zirconium composition positioned about the fissionable fuel pellets and the neutron-moderator matrix.

9. The organically cooled nuclear reactor of claim 1, wherein cladding comprising at least one of zirconium alloy, silicon carbide or iron lines the neutron-moderator matrix and separates the neutron-moderator matrix from the fissionable fuel pellets.

10. The organically cooled nuclear reactor of claim 1, wherein the coolant is substantially free of water.

11. The organically cooled nuclear reactor of claim 1, wherein the organic coolant comprises at least one of a terphenyl composition and a dimethyl polysiloxane.

12. The organically cooled nuclear reactor of claim 1, wherein the neutron-moderator matrix is in a solid form and comprises at least one of graphite and zirconium hydride.

13. A method for generating power via nuclear fission in a nuclear reactor that includes fissionable fuel pellets and a neutron-moderator matrix in which the fissionable fuel pellets are distributed, wherein the neutron-moderator matrix also defines coolant channels, the method comprising:
generating a controlled fission reaction in the fuel pellets, resulting in a release of neutrons and heat generation;
moderating the released neutrons with the neutron-moderator matrix; and
flowing organic coolant through the coolant channels to extract the generated heat.

14. The method of claim 13, wherein the nuclear reactor operates with a power density in a range from 40-60 KW/L.

15. The method of claim 13, wherein the nuclear reactor is operated at a temperature in a range of about 250° C. to about 400° C. and at a pressure in a range of about 50 to about 1 MPa.

16. The method of claim 13, further comprising:
shutting down the reactor; and
cooling the reactor after shutdown mostly or entirely by air cooling.

17. The method of claim 13, further comprising operating a camera in the nuclear reactor to monitor inventory of the fissionable fuel pellets in the nuclear reactor.

18. The method of claim 13, wherein the organic coolant comprises at least one of a terphenyl composition and a dimethyl polysiloxane.

19. The method of claim 13, further comprising forming the fuel pellets from plutonium in weapons or from a used nuclear fuel stockpile.
